(19) United States
(12) Patent Application Publication
(10) Pub. No.: US 2002/0171785 A1
(43) Pub. Date: Nov. 21, 2002

(54) Dynamic projection lighting decoration

(76) Inventor: Jen-Yen Yen, Lu Chou (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/859,446

(22) Filed: May 18, 2001

(51) Int. Cl. G02F 1/136

(52) U.S. Cl. 349/61

(57) ABSTRACT

A dynamic projection lighting decoration comprises a base with a liquid projection mechanism, a projection time display and a moving projection lamp to project flashing, glaring light and display current time on ceiling for better novel effects.

### BACKGROUND OF THE INVENTION

I. Field of the Invention

This invention relates generally to a dynamic projection lighting decoration and, more specifically, to a dynamic projection lighting decoration consists of a liquid projection mechanism, a projection time display and a moving projection lamp to project flashing, glaring light and display current time on ceiling.

II. Description of the Prior Art

Heretofore, it is known lighting decorations generally are a base covered with a lampshade and has a lamp inside to shine, normally they have fixed structure, simple and dull without novelty.

It is also known most of the lampshades are transparent or semi-transparent in simple tone without variety.

It is also known most of the clocks are mechanical style with hands or electrical style with digital display, people have to look at the clocks to know the current time. The display of clocks have little change, the only change is from mechanical display to digital LCD (Liquid Crystal Display).

### SUMMARY OF THE INVENTION

It is therefore a primary object of the invention to provide a dynamic projection lighting decoration comprising a base with a liquid projection mechanism, a projection time display and a moving projection lamp to project flashing, glaring light and display current time on ceiling.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a front view of the present invention;

FIG. 2 is a rear view of the present invention;

FIG. 3 is a cross-sectional view of the present invention;

FIG. 4 shows a shell of the present invention moving downward;

FIG. 5 is another embodiment of the circuit diagram of the present invention;

### DESCRIPTION OF THE PREFERRED EMBODIMENT

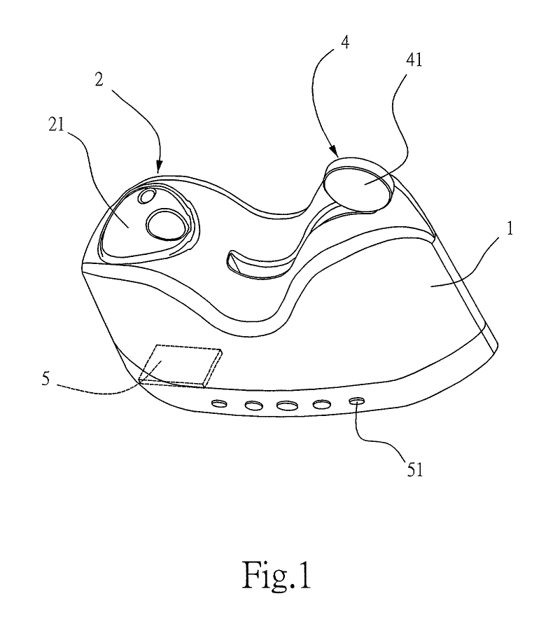

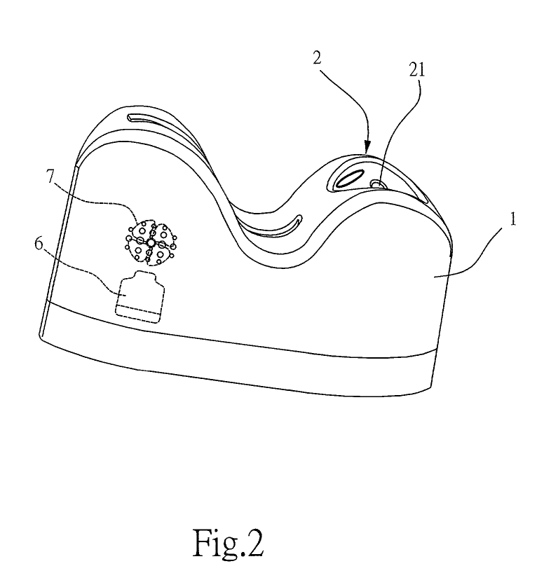

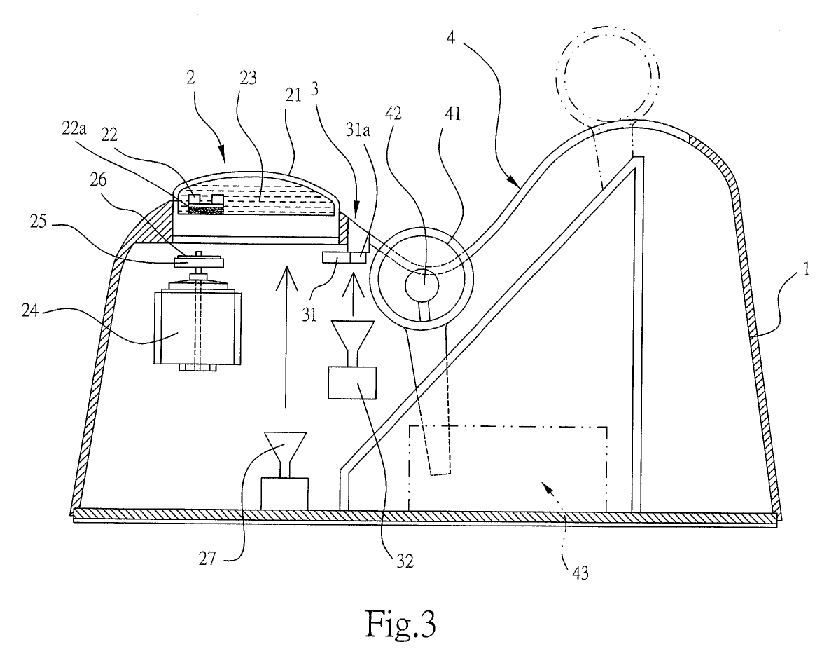

Referring to FIG. 1, FIG. 2 and FIG. 3, the present invention is composed of a base 1 with a liquid projection mechanism 2, a projection time display 3 and a moving projection lamp 4.

The liquid projection mechanism 2 is on one side of the base 1. The liquid projection mechanism 2 consists of a transparent container 21 that is on top of the body 1; a propeller 22 and liquid 23 are inside the transparent container 21, a magnet 22a is on the bottom of the transparent container 21. A motor 24 with a rotor 25 is beneath the transparent container 21; another magnet 26 is on top of the rotor 25. A light source A 27 is beneath the transparent container 21.

The projection time display 3 is on top of the body 1. The projection time display 3 composes of a LCD time display 31 and a transparent plate 31a. Another light source B 32 is beneath the transparent plate 31a.

The moving projection lamp 4 is on the other side of the body 1. The moving projection lamp 4 composes of a shell 41 with a light source C 42 inside, the shell is pushed and pulled by another motor 43 to move back and forth.

Based on above description, the motor 24 of the liquid projection mechanism 2 drives the rotor 25, the magnet 26 on the motor 25 moves the magnet 22a beneath the propeller 22 of the transparent container 21. The propeller 22 stirs the liquid 23 of the transparent container 21 to generate ripples. The light source A 27 passes through the transparent container 21 and shines on the ceiling to achieve the glaring effect.

The light source B 32 beneath the transparent plate 31 a can project current time of the LCD time display 31 on the ceiling, another way of showing time, and a novelty.

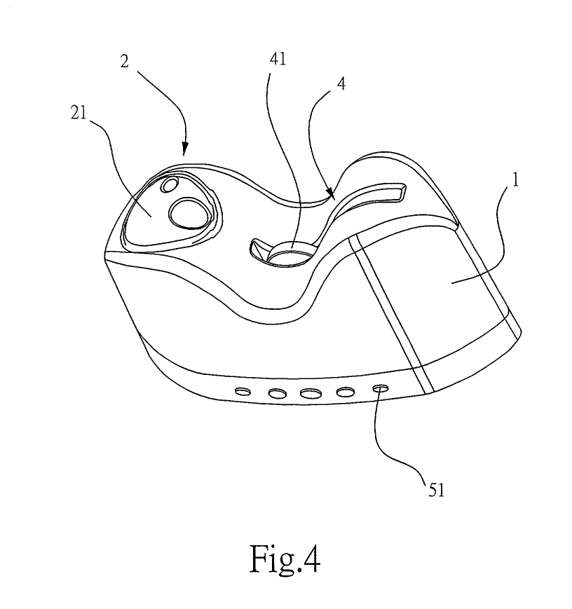

The shell 41 of the moving projection lamp 4 has a light source C 42 internally, the shell is pushed and pulled by another motor 43 to move back and forth and shine, as shown on FIG. 1 and FIG. 4, such arrangement offers dynamic flashing light.

A control circuitry 5 is inside the body 1, on one side near bottom of the body 1 has plurality number of selection button 51 to control the control circuitry 5. The selection button 51 are connected to the control circuitry 5. A timer circuit of the control circuitry 5 can activate or turn off the liquid projection mechanism 2, the projection time display 3 and the moving projection lamp 4 at preset time.

An audio circuit is inside the body 1 to play music or generate sound effects according to the movements, actions of the liquid projection mechanism 2, the projection time display 3 and the moving projection lamp 4 for better novel effects.

Referring to FIG. 2, a container 6 with fragrance is inside the body 1; a fan 7 is beside the container 6 to blow the fragrance out. The fan 7 is controlled by the control circuitry 5 to start or turn off.

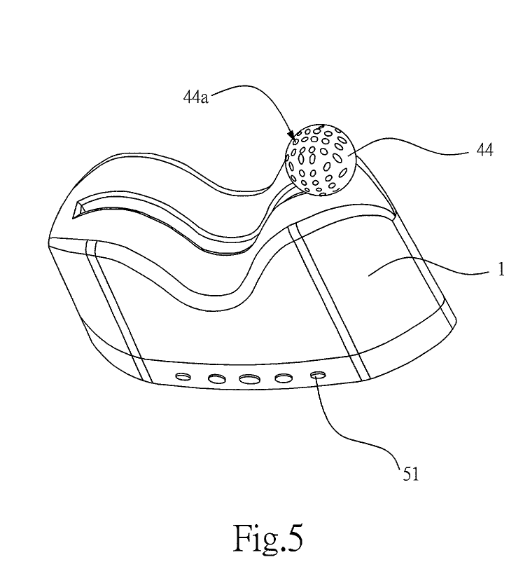

Referring to FIG. 5, the shell 41 can be a hollow ball 44 with hole 44a on surface. The light source C 42 is inside the hollow ball 44. This is another implementation example.

While a preferred embodiment of the invention has been shown and described in detail, it will be readily understood and appreciated that numerous omissions, changes and additions may be made without departing from the spirit and scope of the invention.

What is claimed is:

1. A dynamic projection lighting decoration comprising:
a base;
a liquid projection mechanism located on one side of said base, said liquid projection mechanism consisting of a transparent container on top of said body, a propeller and liquid within said transparent container, a magnet on the bottom of said transparent container, a motor with a rotor situated beneath said transparent container, another magnet is on top of said rotor, a light source A is beneath said transparent container;
a projection time display on top of said body, said projection time display composing of a LCD time display, a transparent plate, another light source B located beneath said transparent plate;
a moving projection lamp located on the other side of said body, said moving projection lamp composing of a shell with a light source C inside, said shell being pushed and pulled by another motor to move back and forth.

2. The dynamic projection lighting decoration recited in claim 1, wherein said base has a built-in control circuitry, on one side near bottom of said body has plurality numbers of selection buttons to control said control circuitry, said selection buttons are connected to said control circuitry, a timer circuit of the control circuitry activates or turns off said liquid projection mechanism, said projection time display and said moving projection lamp at preset time.

3. The dynamic projection lighting decoration recited in claim 1, wherein said base has a built-in audio circuit to play music or generate sound effects according to the movements, actions of said liquid projection mechanism, said projection time display and said moving projection lamp.

4. The dynamic projection lighting decoration recited in claim 1, wherein said base has a built-in container with fragrance, a fan located beside said container to blow the fragrance out.
